(19) United States
(12) Patent Application Publication
(10) Pub. No.: US 2013/0116613 A1
(43) Pub. Date: May 9, 2013

(54) VETERINARY DRESSING WRAP

(71) Applicant: Therese Leigh Entler, Vancouver, WA (US)

(72) Inventor: Therese Leigh Entler, Vancouver, WA (US)

(21) Appl. No.: 13/288,248

(22) Filed: Nov. 3, 2011

(51) Int. Cl. A61D 9/00

(52) U.S. Cl. 602/79

(57) ABSTRACT

A veterinary dressing wrap for positioning and holding a medical dressing on a wound site located on the leg of an animal providing both protection for the leg as well as breathability and moisture control at the wound site.

### BACKGROUND OF THE INVENTION

1. Field of the Invention

The present invention generally relates to a veterinary dressing wrap mountable on a pet's leg to protect the animal as well as provide a platform for a medical dressing useful in treatment and/or healing of an injury to said pet. More particularly the present invention relates to a veterinary dressing wrap that has a breathable portion to allow air in and moisture out thereby helping in the healing or treatment of an injury further having a reusable fixing means for securely positioning said dressing wrap substantially preventing displacement or removal of said dressing wrap by the animal or its movements. Still more particularly the present invention relates to a veterinary dressing wrap into which one or more dressings or medical sponges may be removably attached to the interior surface of said veterinary dressing wrap to help promote the healing of an injury to the leg of an animal.

2. Description of the Related Art

The use of wound covering veterinary wraps for animals, particularly pets, most particularly dogs and cats, for protection from weather and/or contamination is known. Some are waterproof or water resistant, and some are neither. However, none of them address the ability to removably mount a medical dressing as well as provide moisture removal from the wrapped site to promote healing and comfort.

Typical of these known pet wrap covers are for example, U.S. Pat. No. 4,376,438 issued Mar. 15, 1983 to Straube et al discloses a hard cast that is more permeable than the traditional plaster of Paris cast comprising a dressing over the area to be covered as a support comprising strips of air permeable flexible fabric coated and/or impregnated with 50 to 300 percent by weight of the uncoated fabric of an isocyanate prepolymer which contains free isocyanate groups and is based on aromatic polyisocyanates and polyols containing tertiary amino nitrogen atoms. This coated fabric is soaked in water and wrapped over the supporting dressing and air hardens in a few minutes creating a rigid one time use cast which must be replaced each time the dressing requires replacing or to inspect the wound area.

U.S. Pat. No. 4,748,971 issued Jun. 7, 1988 to Richter et al discloses a stiff water resistant laminated veterinary or medical dressing formed by using two separate layers each being of different composition to form a hardened cast. There is no teaching of air or moisture permeability.

U.S. Pat. No. 5,103,769 issued May 7, 1991 to Murray et al discloses a multi-component liquid bandage which can be used directly on the skin and over the lesion area. It doesn't teach air or moisture permeability. It further teaches that is a replacement for traditional dressings used to cover wounds.

And U.S. Pat. No. 5,503,908 issued Apr. 2, 1996 to Faass discloses another type of bandage comprising a stretchable self-adhesive fabric that can be wrapped to prevent injury or re-injury to skin, tendons, muscles and/or ligaments as well as provide support. It doesn't teach the ability to attach a medical dressing to the tape prior to application.

Thus there remains a need for a veterinary dressing wrap into which a medical dressing can be optionally removably mounted to protect a wounded leg and/or maintain medication upon the wound site, particularly a leg pat wound site; which promotes moisture removal and air exchange; and one that is resistant to removal by the animal.

### DISCLOSURE OF THE INVENTION

The present invention provides advantages and alternatives over the prior art by providing a veterinary dressing wrap that protect the animal's leg from wet and dirty conditions while promoting healing of the wound site by encouraging body moisture removal and air flow to the wound site.

According to a further aspect of the present invention, there is provided a veterinary dressing wrap that can be easily, securely, and comfortably mounted on an animal's leg while being resistant to the animal removing said veterinary dressing wrap, and further providing a secure but easily changeable wound dressing.

According to yet another aspect of the present invention there is provided a veterinary dressing wrap for positioning and holding a medical dressing on an animal leg wound site comprising in cooperative combination: a substantially rectangular tape-like body of desired dimensions having a first end, a second end, a first side, a second side, and having interior and exterior surfaces; said rectangular tape-like body upper portion comprising an air and moisture breathable flexible tri-laminate material; said rectangular tape-like exterior surface comprising a water resistant or waterproof tactile flexible material and interior surface comprising a medical dressing mounting area; a securing hook material fixedly attached on said interior surface along a desired portion of said first side of said rectangular tape-like body; a securing hook material fixedly attached on said interior surface along a desired portion of said first end of said rectangular tape-like body; a removably mounted medical dressing; thereby creating a desired veterinary dressing wrap holding a medical dressing in a desired position on an animal's leg.

According to still another aspect of the present invention there is provided a veterinary dressing wrap for positioning and holding a medical dressing on an animal leg wound site providing improved fit and improved wearing comfort through elimination of the need to use pressure and or medical tape to keep the dressing securely in position.

According to still yet another aspect of the present invention there is provided a veterinary dressing wrap for positioning and holding a medical dressing on an animal leg wound site providing improved wearing comfort comprising a breathable synthetic fabric/breathable neoprene material and an easily securable and replaceable medical dressing.

The present invention thus advantageously provides an animal veterinary dressing wrap that has a breathable body portion, and the ability to removably mount a dressing or medical sponge to the interior of said veterinary dressing wrap to protect a wound site and/or retain medication on a wound site. Further, the present invention advantageously provides the above benefits with a veterinary dressing wrap that is both comfortable and resistant to the animal removing it.

### BRIEF DESCRIPTION OF THE DRAWINGS

FIG. 1 shows a plan view of one preferred embodiment of the present invention in an open position ready to wrap onto an animal's leg.

FIG. 2 shows a plan view of another preferred embodiment of the present invention having a medical dressing or sponge mounted thereon in an open position ready to wrap onto an animal's leg.

FIG. 3 shows a preferred embodiment of the present invention mounted on a canine.

### DESCRIPTION OF THE PREFERRED EMBODIMENTS OF THE INVENTION

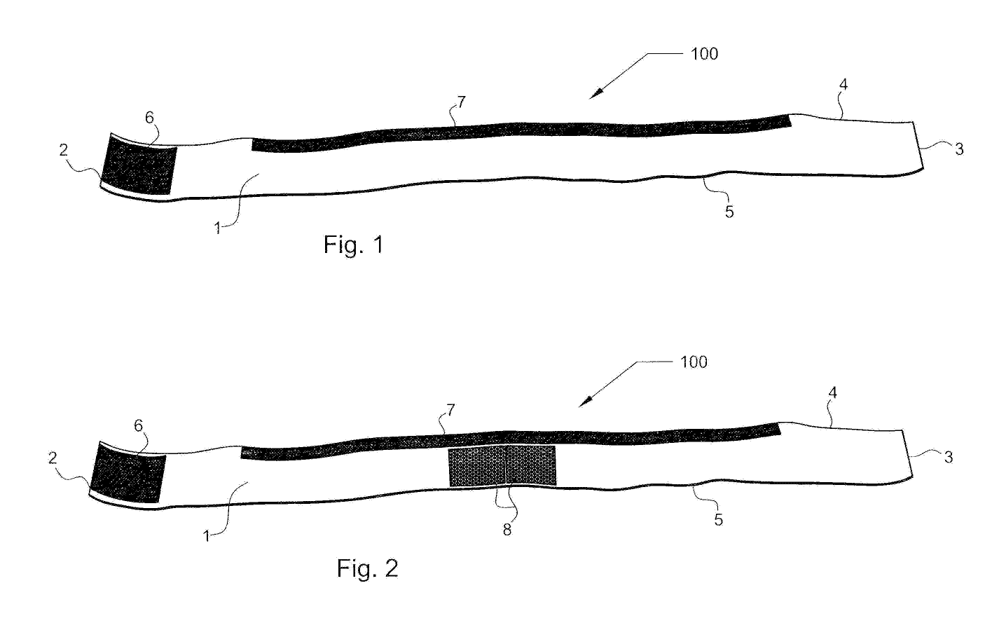

Reference will now be made to the drawings, wherein to the extent possible like reference numerals are utilized to designate like components throughout the various views. Referring to FIG. 1, which presents a plan view of the interior surface of one preferred embodiment of a veterinary dressing wrap 100 of the present invention showing a veterinary dressing wrap material having a substantially rectangular shape of desired dimensions 1 including a first end 2 and second end 3 and a first side 4 and second side 5. Said first end 2 having a securing means 6 fixedly thereon, and said first side 4 having a substantially rectangular shape hook tape 7 of desired dimensions fixedly attached along said first side 4. Said hook tape 7 having dimensions less than those of said dressing wrap 1 and preferably comprising a low hook profile.

Referring now to FIG. 2 there is shown which presents a plan view of the interior surface of one preferred embodiment of a veterinary dressing wrap 100 of the present invention showing a veterinary dressing wrap material having a substantially rectangular shape of desired dimensions 1 including a first end 2 and second end 3 and a first side 4 and second side 5. Said first end 2 having a securing means 6 fixedly thereon, and said first side 4 having a substantially rectangular shape hook tape 7 of desired dimensions fixedly attached along said first side 4. Further, there is shown at least one wound dressing 8 removably securable to said dressing wrap material 1. Said hook tape 7 having dimensions less than those of said dressing wrap 1 and preferably comprising a low hook profile.

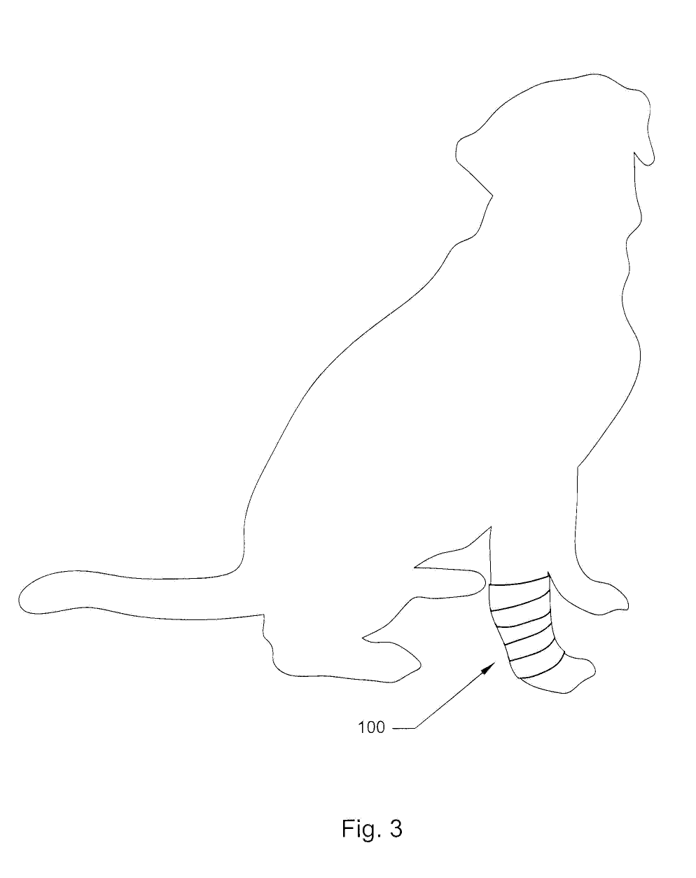

Finally, referring to FIG. 3 there is shown a perspective view of the veterinary dressing wrap 100 of the present invention mounted on a canine leg.

The presently preferred veterinary dressing wrap material 1 is one that promotes the transfer of air and moisture to and from the wound site to help promote healing. Particularly preferred is the Breath-O-prene brand tri-laminate material, as disclosed in U.S. Pat. No. 6,861,379 incorporated herein by reference, from AccuMED Technologies of Buffalo, N.Y. Most preferred are Breath-O-prene materials having a nylon spandex blend fabric on one surface and an unbroken loop (UBL) fabric on the other side with an open cell polyurethane center layer. The presently preferred securing means 7 is a low profile hook and loop tape particularly Velcro brand from Velcro USA of Manchester, N.H. Especially preferred is the use of Velcro hook material and unbroken loop (UBL fabric surface of the side of said veterinary dressing wrap material forming the securing means of the present invention. The presently preferred gauze is gauze made of 30% polyester and 70% viscose manufactured by Kingphar Medical Material Co., Ltd of Hubei, China. The presently preferred adhesive films are double coated pressure sensitive adhesive films comprise a thin polyester film double coated with removable acrylic adhesive on one side and a high performance permanent rubber adhesive on the other side, manufactured by Scapa North America in Windsor, Conn. The most preferred veterinary dressing or medical sponge 8 comprises a multiple layer material having sterile gauze covered on a first surface/side by a polyethylene (PE) film wherein the film is perforated to allow passage of air and moisture into the sterile gauze material and a polyester film double coated with a removable acrylic adhesive on the second surface/side of said medical dressing 8. The adhesive on the first surface/side attaching the polyester film to the sterile gauze material and the second surface/side covered by a removable adhesive protecting layer which is removed before the medical dressing 8 is removably securable to said dressing wrap material 1. Preferably the adhesives used are latex free, and can be of any suitable formulation. The presently preferred gauze comprises 30% polyester and 70% viscose fabric.

The various components of the present invention are preferably sewn together using nylon or Dacron thread using well known techniques in the sewing arts. However, it is to be appreciated that the manner of attachment of the various components to one another may be by any suitable well known method, such as, for example, adhesives, heat welding, sonic welding, and the like. It is further to be appreciated that while the present invention provides flexibility in fitting to various sized animal legs this can be further enhanced as to fit and comfort by providing the veterinary wrap of the present invention in a variety of physical sizes.

In practice the veterinary dressing wrap of the present invention initially unwrapped as a flat tape or open position (see FIGS. 1-2). At least one medical dressing 8 is positioned as desired on the interior surface of the veterinary dressing wrap 100. The veterinary dressing wrap 100 is then positioned on the animals wounded leg starting with second end 3 and spiral wrapped up or down the leg with the first side 1 and hook tape 7 overwraps each preceding wrap thereby locking the veterinary dressing wrap 1 around said wounded leg and further such that the medical dressing 8 covers the wound site. The veterinary dressing wrap securing is completed by hooking the securing means 6 to the exterior surface of veterinary dressing wrap material 1 on the animal's.

Although the preferred embodiments of the present invention has been disclosed, various changes and modifications may be made without departing from the scope of the invention as set forth in the appended claims.

What is claimed is:

1. A veterinary dressing wrap for positioning and holding a medical dressing on an animal leg wound site comprising in cooperative combination:
a substantially rectangular tape-like body of desired dimensions having a first end, a second end, a first side, a second side, and having interior and exterior surfaces;
said rectangular tape-like body upper portion comprising an air and moisture breathable flexible tri-laminate material;
said rectangular tape-like exterior surface comprising a waterproof tactile flexible material and interior surface comprising a medical dressing mounting area;
a securing hook material fixedly attached on said interior surface along a desired portion of said first side of said rectangular tape-like body;
a securing hook material fixedly attached on said interior surface along a desired portion of said first end of said rectangular tape-like body;
a removably mounted medical dressing;
thereby creating a desired veterinary dressing wrap holding a medical dressing in a desired position on an animal's leg.

2. The veterinary dressing wrap for positioning and holding a medical dressing on an animal leg wound site as claimed in claim 1 wherein, said substantially rectangular tape-like body of desired dimensions comprises a breathable tri-laminate comprising an open-cell foam having an interior surface and an exterior surface covered on said open-cell foam interior surface and said exterior surface by four-way stretchable fabric designed to wick moisture and allow air exchange.

3. The breathable tri-laminate as claimed in claim 2 wherein, said four-way stretchable fabric on both said interior and said exterior surfaces is a nylon and spandex blend fabric.

4. The breathable tri-laminate as claimed in claim 2 wherein, said four-way stretchable fabric is a nylon and spandex blend fabric on said interior surface of said open-cell foam and an unbroken loop (UBL) fabric on said exterior surface of said open-cell foam.

5. The securing and releasing materials as Claimed in claim 1 wherein, said materials are co-operatively positioned hook containing tape and unbroken loop (UBL) fabric on said exterior surface of said tape-like body.

6. The medical dressing mounting area as claimed in claim 1 wherein, said mounting area comprises a smooth surfaced Lycra fabric.

7. The veterinary dressing wrap as claimed in claim 1 wherein, said securing hook material comprises a soft, low profile hook material.

8. A veterinary dressing wrap for positioning and holding a medical dressing on an animal leg wound site comprising in cooperative combination:
a substantially rectangular tape-like body of desired dimensions having a first end, a second end, a first side, a second side, and having interior and exterior surfaces;
said rectangular tape-like body upper portion comprising an air and moisture breathable flexible tri-laminate material;
said rectangular tape-like exterior surface comprising a waterproof tactile flexible material and interior surface comprising a medical dressing mounting area;
a securing hook material fixedly attached on said interior surface along a desired portion of said first side of said rectangular tape-like body;
a securing hook material fixedly attached on said interior surface along a desired portion of said first end of said rectangular tape-like body;
a removably mounted medical dressing;
thereby creating a desired veterinary dressing wrap holding a medical dressing in a desired position on an animal's leg.

9. The veterinary dressing wrap for positioning and holding a medical dressing on an animal leg wound site as claimed in claim 8 wherein, said substantially rectangular tape-like body of desired dimensions comprises a breathable tri-laminate comprising an open-cell foam having an interior surface and an exterior surface covered on said open-cell foam interior surface and said exterior surface by four-way stretchable fabric designed to wick moisture and allow air exchange.

10. The breathable tri-laminate as claimed in claim 8 wherein, said four-way stretchable fabric on both said interior and said exterior surfaces is a nylon and spandex blend fabric.

11. The breathable tri-laminate as claimed in claim 8 wherein, said four-way stretchable fabric is a nylon and spandex blend fabric on said interior surface of said open-cell foam and an unbroken loop (UBL) fabric on said exterior surface of said open-cell foam.

12. The securing and releasing materials as claimed in claim 8 wherein, said materials are co-operatively positioned hook containing tape and unbroken loop (UBL) fabric on said exterior surface of said tape-like body.

13. The medical dressing mounting area as claimed in claim 8 wherein, said mounting area comprises a smooth surfaced Lycra fabric.

14. The veterinary dressing wrap as claimed in claim 8 wherein, said securing hook material comprises a soft, low profile hook material.
